(19) United States
(12) Patent Application Publication
(10) Pub. No.: US 2026/0185958 A1
(43) Pub. Date: Jul. 2, 2026

(54) SENSOR ELEMENT AND GAS SENSOR

(71) Applicant: Niterra Co., Ltd., Nagoya-shi, Aichi (JP)

(72) Inventors: Kazuma ITO, Nagoya-shi, Aichi (JP); Wakako NANYA, Nagoya-shi, Aichi (JP); Masaki MIZUTANI, Nagoya-shi, Aichi (JP)

(73) Assignee: Niterra Co., Ltd., Nagoya-shi, Aichi (JP)

(21) Appl. No.: 19/125,589

(22) PCT Filed: Aug. 22, 2023
(86) PCT No.: PCT/JP2023/030125

§ 371 Date: Apr. 29, 2025

(30) Foreign Application Priority Data
Nov. 8, 2022 (JP) 2022-178658

(51) Int. Cl. G01N 27/407; G01N 27/409

(52) U.S. Cl. CPC G01N 27/4077; G01N 27/4071; G01N 27/4075; G01N 27/409

(57) ABSTRACT

A sensor element includes an element body including a detection portion and a porous protection layer which has two or more layers and surrounds at least the periphery of a forward end portion of the element body where the detection portion is located. At least one layer of the porous protection layer is a mixture layer which includes a catalyst supported region where a catalyst substance formed of one or more noble metals selected from a group consisting of Pt, Pd, Rh, and Au is supported, and a non-catalyst region which does not contain the catalyst substance. The catalyst supported region of the mixture layer is present in the entirety of an imaginary region which extends in a thickness direction of the porous protection layer and reaches the outer surface of the porous protection layer.

### TECHNICAL FIELD

The present invention relates to a sensor element used in a gas sensor which is preferably used for detection of the concentration of a particular gas contained in, for example, combustion gas or exhaust gas discharged from a combustor, an internal combustion engine, or the like, and to the gas sensor.

### BACKGROUND ART

As a gas sensor for detecting the concentration of oxygen in exhaust gas discharged from an automobile or the like, there has been known a gas sensor which includes a sensor element in which a detection electrode and a reference electrode are provided on the surface of a tubular or plate-shaped solid electrolyte. In addition, a porous electrode protection layer for preventing poisoning of the detection electrode is formed on the surface of the detection electrode.

Moreover, there has been developed a technique for enhancing gas detection accuracy and response or stabilizing sensor output by forming the porous electrode protection layer such that catalyst particles formed of a noble metal (e.g., Pt) are supported by the electrode protection layer and causing a particular component of exhaust gas having passed through the porous protection layer to react with the catalyst particles (Patent Literature 1).

### CITATION LIST

### Patent Literature

Patent Literature 1: JP2017-83289A

### SUMMARY OF INVENTION

### Technical Problem

However, there is a desire to reduce the amounts of noble metals used, in consideration of the soaring price of noble metals and for reduction of costs. In addition, there is a problem that, if the electrode protective layer contains more noble metal catalyst particles than necessary, the response to gas rather decreases in periods in which exhaust gas is burning due to the catalyst particles and the burned oxygen is bonded to the catalyst particles.

In view of this, an object of the present invention is to provide a sensor element which reduces the amount of a noble metal catalyst supported on a porous carrier and suppresses a decrease in response to gas due to excessive presence of the catalyst, and a gas sensor containing the sensor element.

### Solution to Problem

In order to solve the above-described problem, a sensor element according to a first mode of the present invention comprises a plate-shaped element body including a detection portion having a solid electrolyte body and detection and reference electrodes disposed on the solid electrolyte body; and a porous protection layer which has two or more layers and surrounds at least a periphery of a forward end portion of the element body where the detection portion is located. The sensor element is characterized in that at least one layer in the porous protection layer is a mixture layer which includes a catalyst supported region where a catalyst substance formed of one or more noble metals selected from a group consisting of Pt, Pd, Rh, and Au is supported, and a non-catalyst region which does not contain the catalyst substance, the sensor element has a gas introduction hole for introducing a gas to be measured to the detection portion, and the catalyst supported region of the mixture layer is present in the entirety of an imaginary region which extends from a contour of the gas introduction hole in a thickness direction of the porous protection layer and reaches an outer surface of the porous protection layer.

A gas to be measured, such as exhaust gas, is introduced from the outer surface of the porous protection layer to the gas introduction hole through the imaginary region along the shortest distance in the thickness direction.

Therefore, in the case where the catalyst supported region is present in the entire imaginary region, the gas to be measured comes into contact with the catalyst substance in the catalyst supported region and reacts (burns). Thus, it is possible to improve the gas detection accuracy and response and stabilize the sensor output.

Since the catalyst supported region is formed only in a portion of at least one layer, including the imaginary region, it is unnecessary to form an excessively large catalyst supported region (formed of a noble metal) in the porous protection layer.

Therefore, the amount of the noble metal catalyst used can be reduced. In addition, it is possible to suppress a decrease in the response to gas that would otherwise be caused by excessive presence of the catalyst; i.e., the excessively large catalyst supported region.

A sensor element according to a second mode of the present invention comprises a tubular element body including a detection portion having a solid electrolyte body and detection and reference electrodes disposed on the solid electrolyte body; and a porous protection layer which has two or more layers and surrounds at least a periphery of a forward end portion of the element body where the detection portion is located. The sensor element is characterized in that the detection section is formed continuously in a circumferential direction of the solid electrolyte body, at least one layer in the porous protection layer is a mixture layer which includes a catalyst supported region where a catalyst substance formed of one or more noble metals selected from a group consisting of Pt, Pd, Rh, and Au is supported, and a non-catalyst region which does not contain the catalyst substance, and the catalyst supported region of the mixture layer is present in the entirety of an imaginary region which extends from the detection portion in a thickness direction of the porous protection layer and reaches an outer surface of the porous protection layer.

A gas to be measured, such as exhaust gas, is introduced from the outer surface of the porous protection layer to the gas introduction hole through the imaginary region along the shortest distance in the thickness direction.

Therefore, in the case where the catalyst supported region is present in the entire imaginary region, the gas to be measured comes into contact with the catalyst substance in the catalyst supported region and reacts (burns). Thus, it is possible to improve the gas detection accuracy and response and stabilize the sensor output.

Since the catalyst supported region is formed only in a portion of at least one layer, including the imaginary region, it is unnecessary to form an excessively large catalyst supported region (formed of a noble metal) in the porous protection layer.

Therefore, the amount of the noble metal catalyst used can be reduced. In addition, it is possible to suppress a decrease in the response to gas that would otherwise be caused by excessive presence of the catalyst; i.e., the excessively large catalyst supported region.

In the sensor element of the present invention, the outermost layer of the porous protection layer may be a layer different from the mixture layer and may be composed of the non-catalyst region.

In this sensor element, since the layer having the catalyst supported region is covered with the outermost layer in which the catalyst supported region is not formed, the catalyst supported region does not come into direct contact with water or a poisoning substance, and it is possible to suppress a decrease in the reactivity of the catalyst.

A gas sensor comprising a sensor element of the present invention for detecting the concentration of a particular gas component in a gas to be measured, and a shell body which holds the sensor element is characterized in that the sensor element is the sensor element as recited in claim 1 or 2.

### Advantageous Effect of Invention

According to this invention, a sensor element which reduces the amount of a noble metal catalyst supported on a porous carrier and suppresses a decrease in response to gas due to excessive presence of the catalyst is obtained.

### BRIEF DESCRIPTION OF DRAWINGS

FIG. 1 Cross-sectional view of a gas sensor (oxygen sensor) according to an embodiment of the present invention, the cross-sectional view being taken in the longitudinal direction of the gas sensor.

FIG. 2 Schematic exploded perspective view of a sensor element.

FIG. 3 Enlarged cross-sectional view of a portion of the sensor element on its forward end side.

FIG. 4 Cross-sectional view taken along line A-A of FIG. 3.

FIG. 5 Schematic cross-sectional view showing another example of a porous protection layer.

FIG. 6 Schematic cross-sectional view showing still another example of the porous protection layer.

FIG. 7 Schematic cross-sectional view showing yet another example of the porous protection layer.

FIG. 8 Perspective view showing a tubular sensor element according to the embodiment of the present invention.

### DESCRIPTION OF EMBODIMENT

An embodiment of the present invention will now be described.

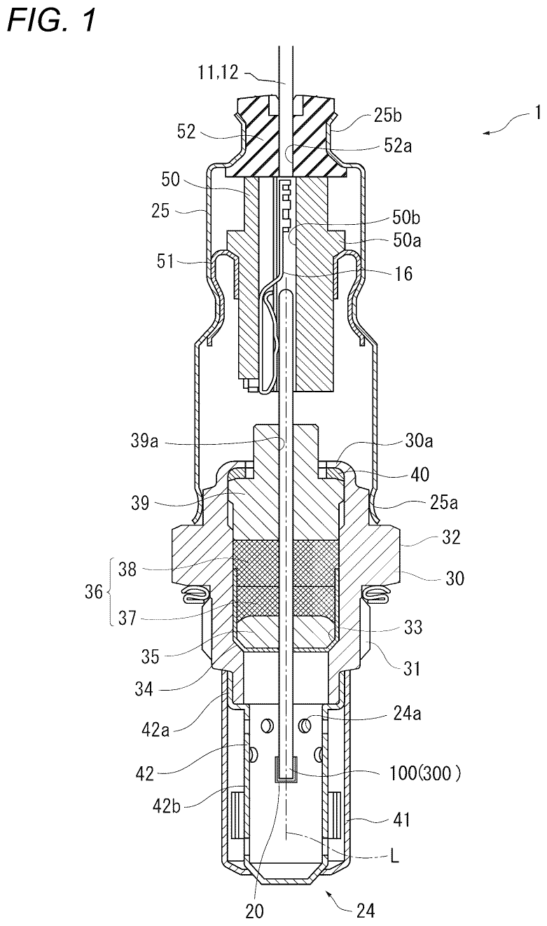

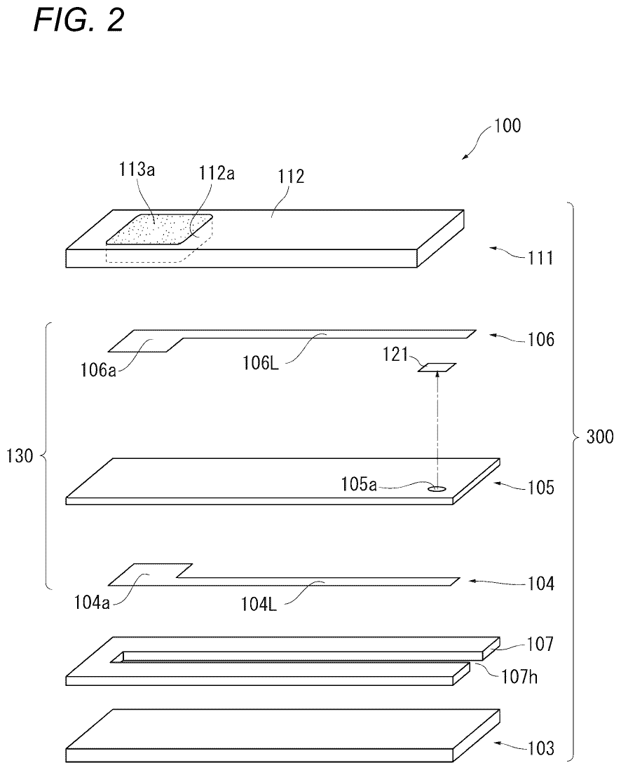

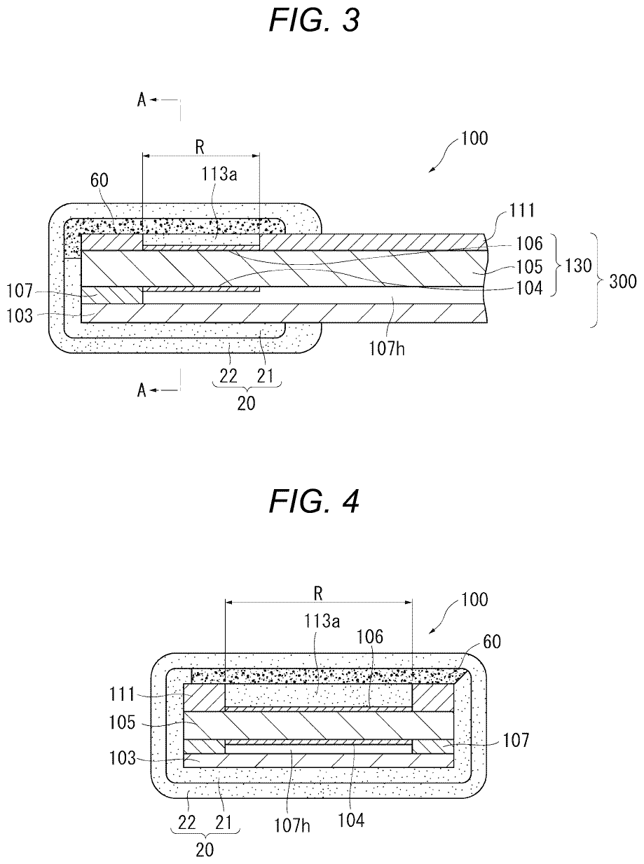

FIG. 1 is a cross-sectional view of a gas sensor (oxygen sensor) 1 according to an embodiment of the present invention, the cross-sectional view being taken in the longitudinal direction (the direction of an axial line L) of the gas sensor 1. FIG. 2 is a schematic exploded perspective view of a sensor element 100. FIG. 3 is an enlarged cross-sectional view of a portion of the sensor element 100 on its forward end side. FIG. 4 is a cross-sectional view taken along line A-A of FIG. 3.

As shown in FIG. 1, the gas sensor 1 includes the sensor element 100, a shell body (metallic shell) 30 which holds the sensor element 100, etc. therein, a protector 24 attached to a forward end portion of the shell body 30, etc. The sensor element 100 is disposed to extend in the direction of the axial line L.

Also, a porous protection layer 20 is provided on the forward end side of the sensor element 100 so as to cover a detection electrode (see FIG. 2).

As shown in FIG. 2, the sensor element 100 includes an oxygen concentration detection cell (detection portion) 130 composed of a solid electrolyte body 105 and a reference electrode 104 and a detection electrode 106 formed on opposite sides of the solid electrolyte 105. The reference electrode 104 has a reference electrode portion 104a and a reference lead portion 104L extending from the reference electrode portion 104a along the longitudinal direction of the solid electrolyte body 105. The detection electrode 106 has a detection electrode portion 106a and a detection lead portion 106L extending from the detection electrode portion 106a along the longitudinal direction of the solid electrolyte body 105.

Notably, in FIG. 2, the porous protection layer 20 is not shown.

A protection layer 111 has a porous electrode protection portion 113a and a reinforcement portion 112. The electrode protection portion 113a prevents poisoning of the detection electrode portion 106a by sandwiching the detection electrode portion 106a between the electrode protection portion 113a and the solid electrolyte body 105. The reinforcement portion 112 protects the solid electrolyte body 105 while sandwiching the detection lead portion 106L between the reinforcement portion 112 and the solid electrolyte body 105. Notably, the sensor element 100 of the present embodiment constitutes a so-called oxygen concentration electromotive force-type gas sensor (0 sensor) which can detect the concentration of oxygen by using the voltage (electromotive force) produced between the electrodes of the oxygen concentration detection cell 130.

The electrode protection portion 113a corresponds to the “gas introduction hole” in claims.

Meanwhile, a lower surface laver 103 and an atmosphere introduction hole laver 107 are stacked on a lower surface of the reference electrode 104 such that the reference electrode 104 is sandwiched between the solid electrolyte body 105 and the lower surface layer 103 and the atmosphere introduction hole layer 107. The atmosphere introduction hole layer 107 has a generally squarish C-like shape with an opening on its rear end side. An internal space surrounded by the solid electrolyte body 105, the atmosphere introduction hole layer 107, and the lower surface layer 103 constitutes an atmosphere introduction hole 107h. The reference electrode 104 is exposed to the atmosphere (reference gas) introduced to this atmosphere introduction hole 107h.

A stack of the lower surface layer 103, the atmosphere introduction hole layer 107, the reference electrode 104, the solid electrolyte body 105, the detection electrode 106, and the protection layer 111 constitutes an element body 300. In the present embodiment, the element body 300 has a plate-like shape.

An end of the reference lead portion 104L is electrically connected to a detection-element-side pad 121 on the solid electrolyte body 105 via a conductor formed in a through hole 105a provided in the solid electrolyte body 105. Meanwhile, the protection layer 111 is shorter in the direction of the axial line L than the end of the detection lead portion 106L, so that the end of the detection lead portion 106L projects from the rear end of the protection layer 111 and appears on the upper surface. The end of the detection lead portion 106L is connected to an external terminal (not shown) for connection of an external circuit.

Notably, the solid electrolyte body 105 has oxygen ion conductivity and may contain, as a main component, for example, a partially stabilized zirconia (YSZ) solid solution prepared by adding yttria as a stabilizer. Herein, the main component refers to a component whose amount is greater than 50 mass % of the solid electrolyte body 3s.

Each of the reference electrode 104 and the detection electrode 106 is formed mainly of Pt, for example. Herein, the expression “mainly of Pt” shows that “the component whose amount is greater than 50 mass % of the electrode is Pt.

Each of the lower surface layer 103, the protection layer 111, and the atmosphere introduction hole layer 107 may be formed of an insulating material such as alumina. The electrode protection portion 113a may be a porous body formed mainly of zirconia. The porous body can be formed, for example, by bonding, through firing or the like, particles of one or more ceramic materials selected from the group consisting of alumina, spinel, zirconia, mullite, zircon, and cordierite. When a slurry containing these particles is fired, an organic or inorganic binder present in the gaps between the ceramic particles and in the slurry burns and disappears, whereby pores are formed in the skeleton of the layer.

Returning to FIG. 1, the shell body 30 is formed of SUS430 and has a male screw portion 31 for attaching the gas sensor to an exhaust pipe and a hexagonal portion 32 with which an attachment tool is engaged when the gas sensor is attached to the exhaust pipe. The shell body 30 has a shell-side step portion 33 protruding radially inward, and the shell-side step portion 33 supports a metallic holder 34 used to hold the sensor element 100.

A ceramic holder 35 and talc 36 are disposed inside the metallic holder 34 in this order from the forward end side. The talc 36 is composed of first talc 37 disposed inside the metallic holder 34 and second talc 38 disposed across the rear end of the metallic holder 34.

The first talc 37 is compressed and packed inside the metallic holder 34, and the sensor element 100 is thereby fixed to the metallic holder 34. The second talc 38 is compressed and packed inside the shell body 30, thereby providing a seal between the outer surface of the sensor element 100 and the inner surface of the shell body 30.

A sleeve 39 formed of alumina is disposed on the rear end side of the second talc 38. This sleeve 39 is formed into a stepped cylindrical shape and has an axial hole 39a extending along the axial line, and the sensor element 100 is inserted into the axial hole 39a. A crimp portion 30a on the rear end side of the shell body 30 is bent inward, so that the sleeve 39 is pressed toward the forward end side of the shell body 30 via a ring member 40 formed of stainless steel.

The protector 24 which is formed of a metal and has a plurality of gas introduction holes 24a is attached, by means of welding, to the outer circumference of a forward end portion of the shell body 30 so as to cover a forward end portion of the sensor element 100 protruding from the forward end of the shell body 30. This protector 24 has a double structure including a closed-end cylindrical outer protector 41 disposed on the outer side and having a uniform outer diameter, and a closed-end cylindrical inner protector 42 disposed on the inner side and formed such that its rear end portion 42a has an outer diameter larger than that of its forward end portion 42b.

A forward end portion of an outer tube 25 formed of SUS430 is fitted into a rear end portion of the shell body 30. A forward end portion 25a of the outer tube 25, which portion is increased in diameter on the forward end side, is fixed to the shell body 30 by means of, for example, laser welding. A separator 50 is disposed inside a rear end portion of the outer tube 25, and a holding member 51 is provided in the gap between the separator 50 and the outer tube 25. This holding member 51 engages with a protruding portion 50a, described later, of the separator 50. When the outer tube 25 is crimped, the holding member 51 is fixed by the outer tube 25 and the separator 50.

An insertion hole 50b into which lead wires 11 and 12 (in FIG. 1, the lead wire 12 is not illustrated because it is hidden behind the lead wire 11) for the sensor element 100 are inserted is formed in the separator 50 so as to extend therethrough from the forward end to the rear end. Connection terminals 16 for connecting the lead wires 11 and 12 to the detection element-side pads 121 of the sensor element 100 are accommodated in the insertion hole 50b. The lead wires 11 and 12 are connected to an unillustrated connector externally. Electric signals are transferred (for input and output of the electric signals) between the lead wires 11 and 12 and an external device such as an ECU through the connector. Although not illustrated in detail, each of the lead wires 11 and 12 has a structure in which a conducting wire is covered with an insulating resin coating.

An approximately cylindrical rubber cap 52 is disposed on the rear end side of the separator 50 so as to close a rear-end-side opening 25b of the outer tube 25. This rubber cap 52 is inserted into the rear end of the outer tube 25 and fixed to the outer tube 25 by crimping the outer circumference of the outer tube 25 radially inward. Insertion holes 52a into which the lead wires 11 to 15 are inserted are formed in the rubber cap 52 so as to extend therethrough from the forward end to the rear end.

Next, the porous protection layer 20 will be described. As shown in FIGS. 3 and 4, the porous protection layer 20 is a porous layer which has two or more porous layers and is provided to cover the entire circumference of the detection portion 130 on the forward end side of the sensor element 100 (the element body 300).

The porous protection layer 20 is formed to contain a forward end surface of the sensor element 100 (the element body 300) and extend along the direction of the axial line L toward the rear end side. As shown in FIG. 4, the porous protection layer 20 is formed to completely surround the four surfaces (i.e., front and back surfaces and opposite side surfaces) of the sensor element 100 (the element body 300). As viewed in the direction of the axial line L, the porous protection layer 20 covers at least a region of the sensor element 100 (the element body 300) which contains the reference electrode portion 104a and the detection electrode portion 106a (this region constitutes the detection portion) and extends from this region to the rear end.

The sensor element 100 may be exposed to a poisoning substance such as silicon and phosphorous contained in exhaust gas, and water droplets in the exhaust gas may adhere to the sensor element 100. Since the outer surface of the sensor element 100 is covered with the porous protection layer 20, it is possible to capture the poisoning substance and prevent water droplets from coming into direct contact with the sensor element 100.

The porous protection layer 20 is a porous body formed by bonding ceramic particles through firing.

In the present example, the porous protection layer 20 is composed of two layers; i.e., an inner layer 21 and an outer layer 22 which covers the inner layer 21, and the outer layer 22 extends toward the rear end side further than does the inner layer 21.

The outer layer 22 corresponds to the “outermost layer” in claims.

Furthermore, a catalyst supported region 60 where a catalytic substance formed of one or more noble metals selected from the group consisting of Pt, Pd. Rh, and Au is provided in a portion of the inner layer 21. The inner layer 21 is a mixture layer where the catalyst supported region 60 and a non-catalyst region containing no catalytic substance are present.

The catalyst supported region 60 is formed on an upper surface of the inner layer 21 to cover the electrode protection portion 113a.

More specifically, the catalyst supported region 60 of the mixture layer (the inner layer 21) is present in the entirety of an imaginary region R which extends from a rectangular contour of the electrode protection portion 113a in the thickness direction of the porous protection layer 20 and reaches an outer surface of the porous protection layer 20. The catalyst supported region 60 is formed to protrude outside the imaginary region R.

Of course, the region where the catalyst supported region 60 is formed may coincide with the imaginary region R. However, since it is difficult to render them completely coincident with each other from the viewpoint of manufacture, the catalyst supported region 6 is formed such that the catalyst supported region 6 protrudes outside the imaginary region R (form the catalyst supported region 6 to contain the imaginary region R). This is easy from the viewpoint of manufacture.

A gas to be measured, such as exhaust gas, is introduced from the outer surface of the porous protection layer 20 to the electrode protection portion 113a (gas introduction hole) through the imaginary region R along the shortest distance in the thickness direction of the porous protection layer 20.

Therefore, if the catalyst supported region 60 is present in the entire imaginary region R, the gas to be measured comes into contact with the catalyst substance in the catalyst supported region 60 and reacts (burns). Thus, it is possible to improve the gas detection accuracy and response and stabilize the sensor output.

In the present invention, since the catalyst supported region 60 is formed in a portion of the inner layer 21, including the imaginary region R, it is unnecessary to form an excessively large catalyst supported region 60 (formed of a noble metal) in the porous protection layer 20.

Therefore, the amount of the noble metal catalyst used can be reduced. In addition, it is possible to suppress a decrease in the response to gas caused by excessive presence of the catalyst, i.e., the excessively large catalyst supported region 60.

The determination as to whether or not the catalyst supported region 60 is present can be made through analysis; i.e., by determining whether or not any of Pt, Pd, Rh, and Au is detected in an EDS (energy dispersive x-ray analysis) image of a cross section of the porous protection layer 20.

A method of forming the catalyst supported region 60 in a portion of the porous protection layer 20 is as follows. After formation of a layer in which the catalyst supported region 60 is to be formed (in the present example, the inner layer 21), a solution containing ions of a noble metal is added dropwise to a site where the catalyst supported region 60 is to be formed, and (after formation of an unfired outer layer 22 thereon), the entirety is calcined.

An example of the noble metal ion containing solution is dinitrodiamine Pt nitrate solution.

In addition, in the present example, since the inner layer 21 having the catalyst supported region 60 is covered with the outer layer 22 (the outermost layer) in which the catalyst supported region 60 is not formed, the catalyst supported region 60 does not come into direct contact with water or a poisoning substance, and it is possible to suppress a decrease in the reactivity of the catalyst.

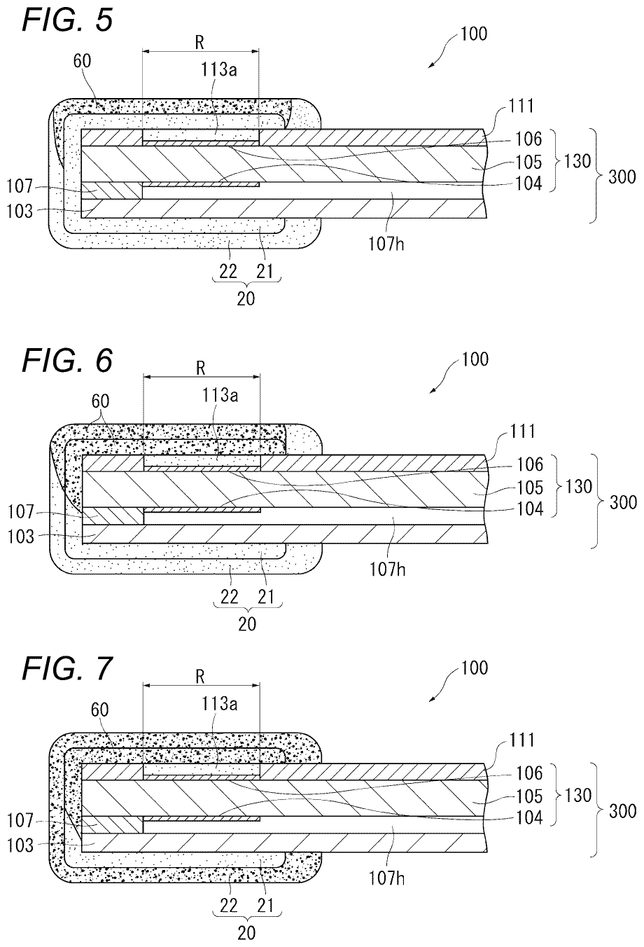

FIG. 5 is a schematic cross-sectional view showing another example of the porous protection layer.

In the example of FIG. 5, the catalyst supported region 60 is formed in a portion of the outer layer 22 to contain the imaginary region R.

FIG. 6 is a schematic cross-sectional view showing still another example of the porous protection layer.

In the example of FIG. 6, the catalyst supported region 60 is formed in a portion of the inner layer 21 and a portion of the outer layer 22 to contain the imaginary region R.

In the example of FIG. 6, after formation of the inner layer 21 and the outer layer 22 through firing, the solution containing ions of a noble metal is added dropwise to a portion of the outer layer 22 in an amount determined such that the solution soaks into the inner layer 21, and the entirety is fired, whereby the catalyst supported region 60 is formed.

FIG. 7 is a schematic cross-sectional view showing yet another example of the porous protection layer.

In the example of FIG. 7, the catalyst supported region 60 is formed in a portion of the inner layer 21 and in the entire outer layer 22 to contain the imaginary region R.

In the example of FIG. 7, after formation of the inner layer 21 through firing, the solution containing ions of a noble metal is added dropwise to a portion of the inner layer 21. Next, a mixture of ceramic particles with a catalyst substance previously supported thereon and burnable particles (carbon, etc.) that form pores is applied, as a slurry which becomes the outer layer 22, to the outer surface of the inner layer 21 by means of dipping or the like, and the entirety is fired.

Alternatively, after the solution containing ions of a noble metal is added dropwise to a portion of the inner layer 21 as described above, the slurry which becomes the outer layer 22 may be prepared as follows. Namely, a mixture of ceramic particles, burnable particles (carbon, etc.) that form pores, and a solution containing noble metal ions is applied to the outer surface of the inner layer 21 by means of dipping or the like, and the entirety is fired, whereby the catalyst supported region 60 is formed.

The present invention is not limited to the above-described embodiment. The sensor element is only required to include a solid electrolyte body, a detection electrode, and a reference electrode and can be applied to the oxygen sensor (the oxygen sensor element) of the present embodiment. However, needless to say, the present invention is not limited to these applications and encompasses various modifications and equivalents which fall within the idea and range of the present invention.

For example, the present invention may be applied to a full-range oxygen sensor having an oxygen pump cell, an NOx sensor (NOx sensor element) for detecting the concentration of NOx in a gas under measurement, an HC sensor (HC sensor element) for detecting the concentration of HC. The sensor element may be a tubular type, and may be a binary sensor or a linear sensor.

The gas sensor may have a heater which generates heat upon energization.

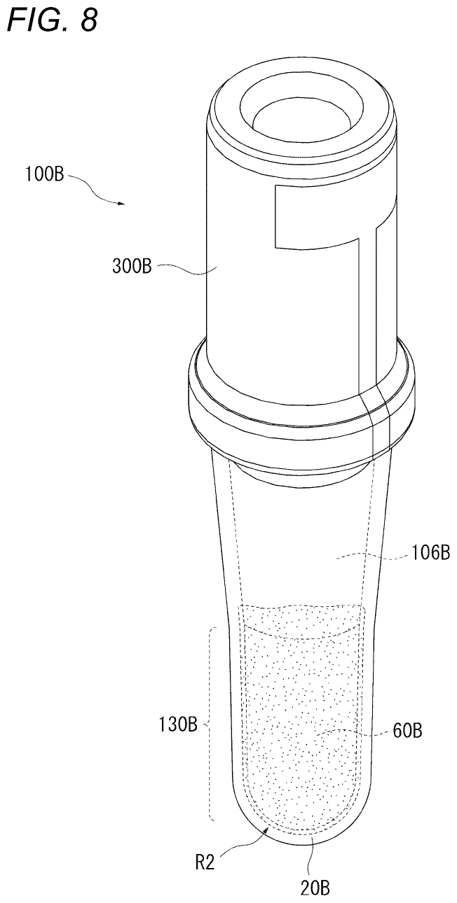

Furthermore, as shown in FIG. 8, the present invention can be applied to a tubular sensor element.

In FIG. 8, a sensor element 100B has a publicly known structure; i.e., includes an element body 300B formed of a tubular solid electrolyte body, a detection electrode 106B formed, continuously in the circumferential direction, on an outer surface of a forward end portion of the element body 300B, and a reference electrode (not shown) formed, continuously in the circumferential direction, on an inner surface of the forward end portion of the element body 300B.

A region where the element body 300B, the detection electrode 106B, and the reference electrode overlap one another serves as a detection portion 130B.

Furthermore, a porous protection layer 20B (composed of two layers in the present example) is provided to surround at least the periphery of the forward end portion of the element body 300B where the detection portion 130B is located.

In the case of the example shown in FIG. 8, the inner layer (not shown) is a mixture layer in which a catalyst supported region 60B and a non-catalyst region are mixedly present.

Notably, in the tubular sensor element 100B, since the detection portion 130B is formed to be continuous in the circumferential direction of the element body 300B, it is sufficient that the catalyst supported region 60B is present in the entirety of an imaginary region R2 which extends from the detection portion 130B in the thickness direction of the porous protection layer 20B and reaches the outer surface of the porous protection layer 20B.

### REFERENCE SIGNS LIST

1: gas sensor
20, 20B: porous protection layer
30: shell body
60, 60B: catalyst supported region
100, 100B: sensor element
104: reference electrode
106, 106B: detection electrode
105, 105B: solid electrolyte body
113a: electrode protection portion (gas introduction hole)
130, 130B: detection portion
300, 300B: element body
R: imaginary region

1. A sensor element comprising: a plate-shaped element body including a detection portion having a solid electrolyte body and detection and reference electrodes disposed on the solid electrolyte body; and a porous protection layer which has two or more layers and surrounds at least a periphery of a forward end portion of the element body where the detection portion is located,
the sensor element being characterized in that
at least one layer in the porous protection layer is a mixture layer which includes a catalyst supported region where a catalyst substance formed of one or more noble metals selected from a group consisting of Pt, Pd, Rh, and Au is supported, and a non-catalyst region which does not contain the catalyst substance,
the sensor element has a gas introduction hole for introducing a gas to be measured to the detection portion, and
the catalyst supported region of the mixture layer is present in the entirety of an imaginary region which extends from a contour of the gas introduction hole in a thickness direction of the porous protection layer and reaches an outer surface of the porous protection layer.

2. A sensor element comprising: a tubular element body including a detection portion having a solid electrolyte body and detection and reference electrodes disposed on the solid electrolyte body; and a porous protection layer which has two or more layers and surrounds at least a periphery of a forward end portion of the element body where the detection portion is located,
the sensor element being characterized in that
the detection section is formed continuously in a circumferential direction of the solid electrolyte body,
at least one layer in the porous protection layer is a mixture layer which includes a catalyst supported region where a catalyst substance formed of one or more noble metals selected from a group consisting of Pt, Pd, Rh, and Au is supported, and a non-catalyst region which does not contain the catalyst substance, and
the catalyst supported region of the mixture layer is present in the entirety of an imaginary region which extends from the detection portion in a thickness direction of the porous protection layer and reaches an outer surface of the porous protection layer.

3. The sensor element according to claim 1, wherein the outermost layer of the porous protection layer is a layer different from the mixture layer and is composed of the non-catalyst region.

4. A gas sensor comprising a sensor element for detecting the concentration of a particular gas component in a gas to be measured, and a shell body which holds the sensor element, characterized in that the sensor element is the sensor element as recited in claim 1.

5. The sensor element according to claim 2, wherein the outermost layer of the porous protection layer is a layer different from the mixture layer and is composed of the non-catalyst region.

6. The gas sensor comprising a sensor element for detecting the concentration of a particular gas component in a gas to be measured, and a shell body which holds the sensor element, characterized in that the sensor element is the sensor element as recited in claim 2.
